(19) United States
(12) Patent Application Publication
(10) Pub. No.: US 2005/0180816 A1
(43) Pub. Date: Aug. 18, 2005

(54) System of structural components for the connection of adjoining, especially stacked, structural parts

(76) Inventor: Frank Greiser, Rheda-Wiedenbruck (DE)

Correspondence Address: MORGAN & FINNEGAN, L.L.P., 3 WORLD FINANCIAL CENTER, NEW YORK, NY, 10281-2101, US

(21) Appl. No.: 11/059,619

(22) Filed: Feb. 15, 2005

(30) Foreign Application Priority Data
Feb. 16, 2004 (DE) 10 2004 007 742.8

(51) Int. Cl. F16D 1/00

(52) U.S. Cl. 403/348

(57) ABSTRACT

The invention relates to a system of structural components for the inter-connection of adjoining, especially stacked, structural parts, whereby each structural part (1) features connecting elements (2) and at least two connecting elements (2) of adjoining connecting parts (1) may be linked, by arranging structural parts (1) next to and/or superimposed on each other, into a connector unit (3) whose hold may be effected by a locking element (4) which interconnects all joined connecting elements (2).

The invention relates to a system of structural components for the inter-connection of adjoining, especially stacked, structural parts, whereby each structural part features connecting elements and at least two connecting elements of adjoining structural parts may be linked by arranging structural parts next to and/or superimposed on each other into a connector unit whose hold may be effected by a locking element which interconnects all linked connecting elements.

Often it is desirable to interconnect different structural parts which may be arranged next to and superimposed on each other, especially where the dimensions of such parts are identical. Known in this regard is arranging the corresponding structural parts over or next to each other, and for example screwing them together to afford a secure hold.

Also known is mounting onto the structural parts matching bar elements, in order to interlink such parts with the aid of the bars. Such a solution is indicated for example in U.S. Pat. No. 4,426,056.

It is further known from DE 102 41 574 A1 to provide on housings connecting elements which, when linked, form a connector unit that may be surmounted by a locking element. The locking element itself, however, lies just loosely over the connector unit and is in turn secured with a separate screw.

The task of the invention is to create a system of structural components for the connection of adjoining structural parts, wherein individual parts may be quickly and comfortably Joined and, in particular, again separated. In particular, where the parts are stacked over and next to each other, even a single part should be easily removable from the overall bond, without the need of separating in advance all the parts from each other.

According to the invention, the task is resolved in that either a connector unit forms an externally threaded peg upon which may be screwed a locking element, or that a bayonet mount and/or a snap-on joint is provided between the connector unit and the locking element.

The essential principle of the invention is that a secure joint is formed directly between the connector unit so formed and the locking element, without the need for further securing measures.

Thus, what the invented solution accomplishes is that structural parts may be arranged at will next to or above each other, whereby the interconnection of such parts may be accomplished by the connecting elements mounted thereon, whereby several (but at least two) connecting elements on adjoining parts are coordinated with each other and such coordinated connecting elements may be linked into a connector unit by the adjoining arrangement of the parts, whereby a connector unit so interlinked according to the invention may be especially easily held together by a securing element.

Hence, what the securing element accomplishes is to secure at one and the same time the joined connector units and the structural parts interlinked thereby to each other.

Where the connecting elements are arranged on a wall, for example a lateral wall of a structural part (for ex. a housing), this also ensures that in linking a number of joined connected parts, each individual part may easily be by itself separated from the bond inasmuch as the connecting elements and/or the linked connector units are accessible from this wall.

An especially simple system of structural components results when the parts are substantially square-shaped, such as is for example customarily the case with housings, for example those accommodating electronic components.

Precisely with such structural parts, the system of component parts may be realized particularly easily when at least one connecting element is arranged in the area of at least one edge of a lateral wall of a structural part and two counter opposed connecting elements of adjoining parts may be joined into a connector unit.

Thus, in two structural parts arranged surmounting or adjoining each other on abutting edges of the lateral walls thereof, each part features at least one connecting element lying opposite another matching connecting element of the adjoining structural part, making it possible to join these connecting elements by the arrangement of the adjoining parts into one connector unit consisting of two individual elements. It is then possible with one locking element to achieve a secure bond of these connecting elements whereby the structural parts may be interconnected.

In another alternative construction, or even one supplemental to the aforesaid embodiment, provision may also be made for a connecting element in the area of at least one corner of the lateral wall of the part, whereby it is possible to link four connecting elements of structural parts arranged next to or above each other into one connector unit. In such a construction, four corresponding structural parts, two of them arranged next to each other and two underneath each other, may be linked in the facing angular regions of the respective lateral walls, whereby a locking element secures the four linked connecting elements to each other.

In the aforesaid embodiments, wherein either two or four connecting elements may be linked into one connector unit, the corresponding connecting elements may be symmetrical to each other, that is identical or mirror-imaged; in other words in an arrangement of two connecting elements, each connecting element may for example constitute approximately one half of the connector unit built by the linkage. Accordingly, in the case of the embodiment with four connecting elements, capable of forming a composite connector unit, each of these connecting elements may be formed as one-quarter of the composite connector unit.

Herein it is advantageous for a connecting element and/or the composite connector unit to project outward from the lateral wall, though not for a connecting element to surmount the lateral limiting edges of the side wall, but especially to remain at all times behind the edge of a lateral wall. This avoids any problem in removing a part from a composite structure in a direction perpendicular to the plane of the lateral wall.

An especially simple construction results when the consolidated connecting elements form a connector unit which may be surmounted by one locking element. Basically, a connector unit formed in this manner may have any desired cross-sectional shape, whereby a circular cross-section is structurally preferred.

According to a first alternative, a connector unit made up of several connector elements may form an externally threaded peg, onto which an internally threaded locking element may be screwed on. To this end, the locking element may for example be formed in the shape of a nut, possessing an internal thread matching the external threading of the connector unit so formed.

Such a nut may, for example, feature a knurled edge in its outer area, for ease in screwing it by hand onto a connector unit. Similarly, provision can be made for the nut to feature recesses, for example to accommodate a screwdriver or a hex wrench.

In the case of a threaded connection between the composite connector unit and a screwed-on locking element, provision may further be made for the diameter of the threaded peg to taper outward, particularly so that the thread diameter diminishes. By analogy, the locking element may be so shaped as to feature a corresponding threaded pitch featuring a declining diameter.

In the event that such a conical formation of the connector unit and of the locking element involves a screw-on connection, it may be simultaneously arranged for the adjoining structural parts to be drawn onto each other on account of their conicity, thereby assuring an especially safe and strong interconnection.

In a further alternative to the mentioned screw-on connection, provision may also be made for a bayonet mount between a connector unit and a locking element, or even a snap-on connection. In the last analysis, an expert can choose any type of connection wherein the locking element surmounts a composite connector unit, thus taking care of the hold.

In all possible connecting structures, it would be preferable for a conical guiding face to be provided on the structural-part end of a connector unit, in particular one matching a guiding face on the structural-part end of a locking element. This would achieve that in placing the locking element upon the connector unit, whether threaded, bayonet mounted, snapped-on or otherwise, the two guiding faces would superimpose, thereby creating a force component attracting the individual structural parts to be connected. As in the case of the conically constructed screw pitch, this would also achieve a particularly secure and strong connection between the parts.

Along with a locking element designed to surmount a connector unit, provision may also be made for a connector unit with a central recess, in particular one formed by joining connecting elements, featuring for example in each connecting element notches so that for the connection of connecting elements into a connector unit a locking element may be inserted into the recess, thereby producing fixation.

In order to achieve a secure and in particular well matched arrangement of the parts to be connected, provision may be made in a further embodiment for the facing boundary surfaces of the connecting elements to be joined to provide matching centering aids on the corresponding structural parts. Such centering aids may be simply constructed as a pin fitting into a hole, whereby provision may for example be made for the pins on these structural parts to be always mounted on the boundary surfaces of the connecting elements facing downward, and that the holes be always arranged on the matching boundary surfaces facing upward. Where the parts are arranged the one after the other, a similar arrangement can also be made for boundary surfaces of the connecting elements facing front or rear.

In a preferred further embodiment, provision may also be made for the connecting elements to be provided with interfaces for the electrical connection of adjoining structural parts. This is especially advantageous when the parts are housings containing electronics, and provision needs to be made for electric supply or signals between the individual parts. Provision may also be made for signals or even electric power to be stored in structural parts by way of connecting elements available unused thereon.

Especially where interfaces are provided in the connecting elements, it may be particularly advantageous if a gasket is inserted between the joined connecting elements, whereby it may be achieved as a particular advantage that the interfaces be protected from possible moisture, dust, or troublesome electromagnetic radiations. The latter effect may often be successfully controlled if the gasket is made in particular of an electrically conducting packing material, thereby preferably creating a sealed electrically conductive casing.

According to the invention, it is basically feasible to provide for the connecting elements to be directly arranged in or on a lateral wall of a structural part to be connected, as for example a housing. Similarly, it is possible to provide according to the invention that a structural part be designed as a wall element, serving in turn for attachment onto a housing. In this manner it may be achieved that available housings, for example electronic modules, be subsequently outfitted with the invented system of structural components, as for example by clamping, screwing on, gluing etc. the invented wall-type parts with the connecting elements onto a wall of the housing.

To this end, such a wall element may, for example, feature along with the connecting elements also additional elements, as for example coolant elements. Such elements may be constructed as ribbed coolants, so that the mounting of a system of structural component parts onto an existing housing may lead to even further advantages, as for example in relation to cooling.

Where structural parts are arranged above or next to each other according to the invented system of structural components, it is possible to leave unused the connecting elements according to the invention which are arranged on the edges or the corners of a structural part, not adjoining any further adjoining part, so that according to the invention it may further be arranged to have such unused connecting elements provided with a cover, especially when the connecting elements feature electric contacts, as for example interfaces.

Such a cover may, for example, be placed with a snap-on connection onto an unused connecting element or even onto two adjoining unused connecting elements.

Examples of embodiment of the invention are illustrated in the following figures

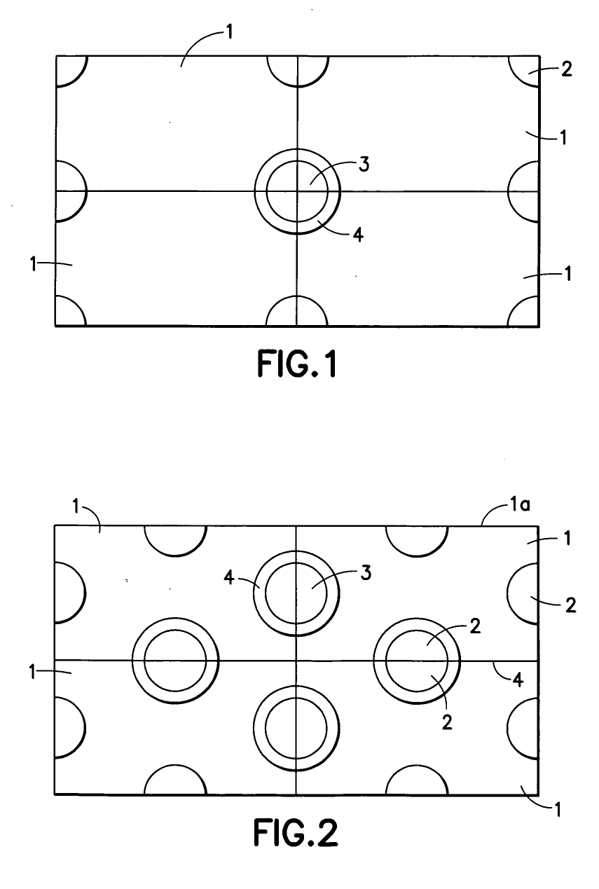

FIG. 1 shows an exemplified arrangement of four adjoining and surmounting structural parts 1 with connecting elements in the corners,

FIG. 2 shows an exemplified arrangement of four adjoining and surmounting structural parts 1 with connecting elements on the edges,

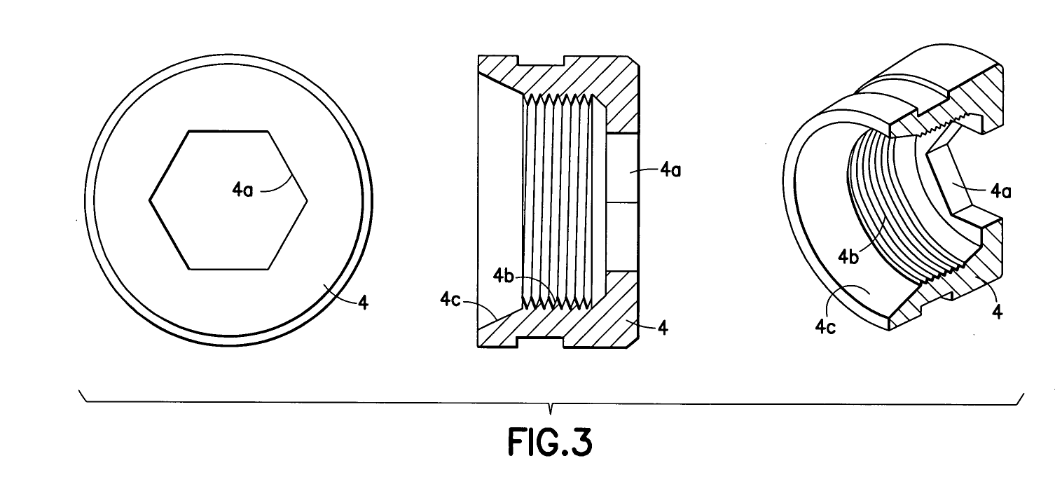

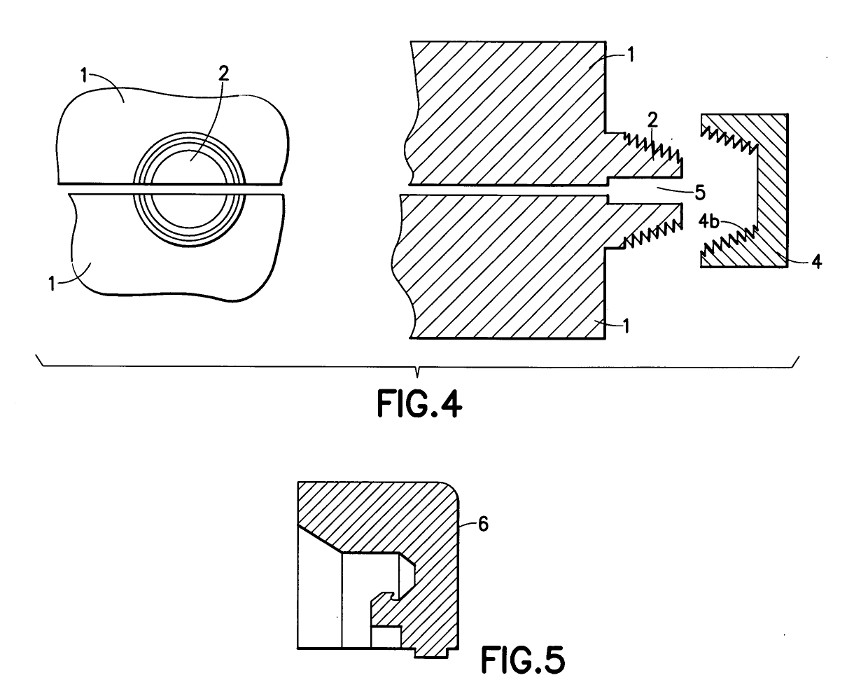

FIG. 3 shows a locking element in the shape of a nut,

FIG. 4 shows connecting elements forming a conical externally threaded connecting unit,

FIG. 5 shows a cross-section of a covering element for covering unused connecting elements,

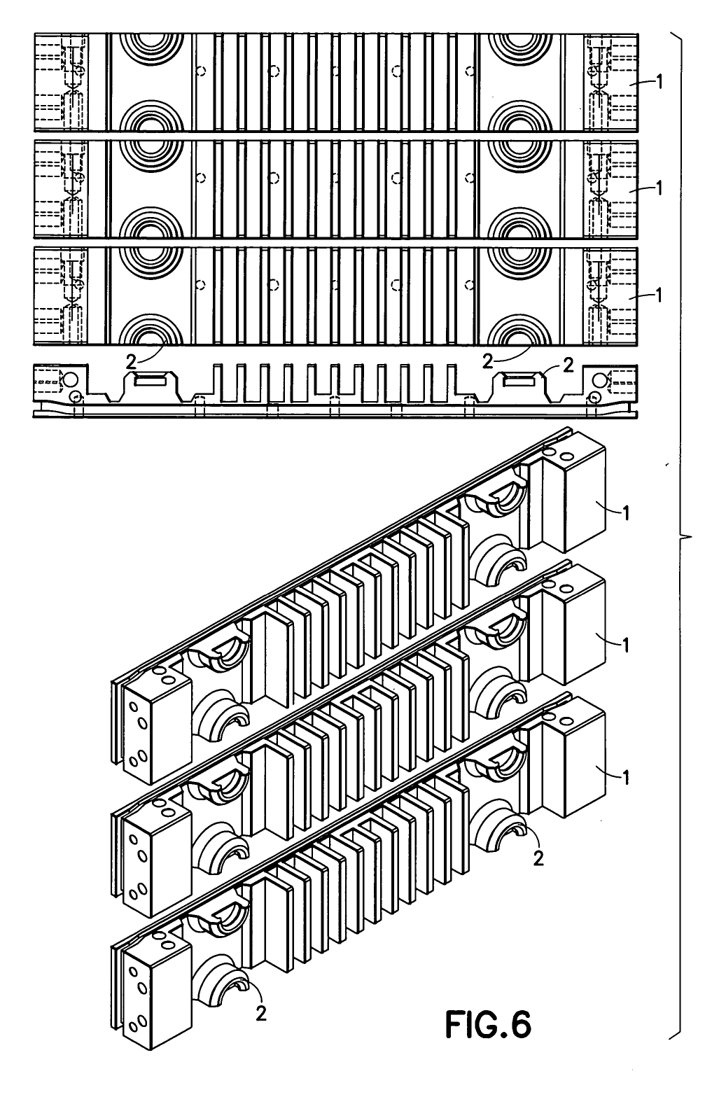

FIG. 6 shows a housing wall element with connecting elements,

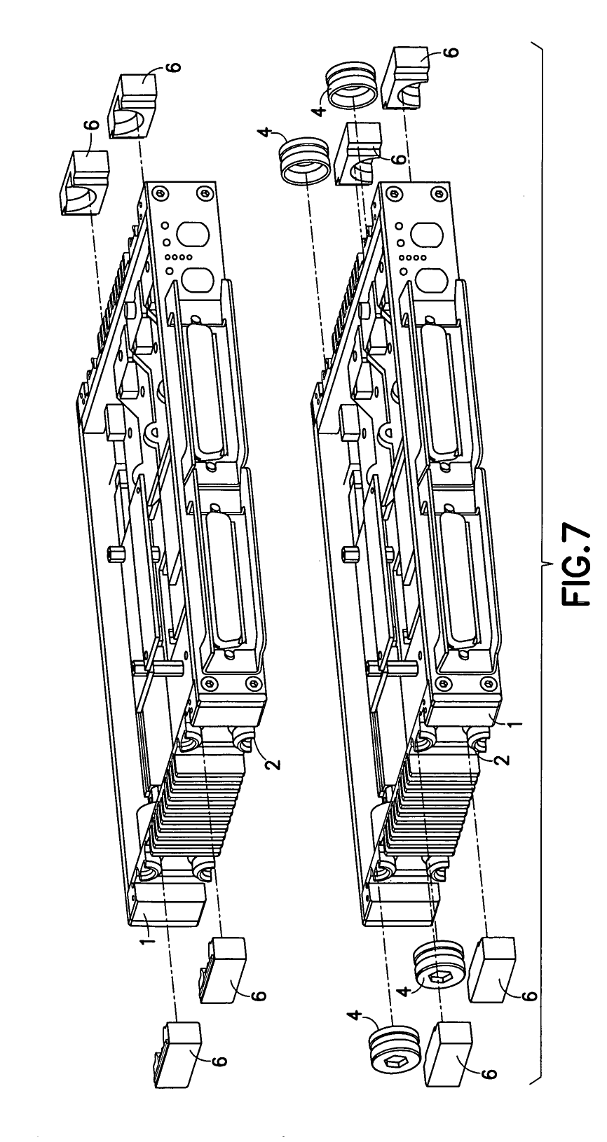

FIG. 7 shows housing wall elements according to FIG. 6 on two superimposed electronic housings illustrating the locking elements and covering elements to be applied thereon.

FIG. 1 is a schematic top view of one of the side walls of housing 1. As can be seen, each of the four illustrated structural parts 1 features in the corner area of a lateral wall a connecting element 2 which in cross-section has a roughly quarter circle shape and projects from the side wall. The quarter-circle cross-section reveals essentially the design of a single connecting element as a longitudinally cut quarter rod. Accordingly, a connecting element 2 may for example represent a quarter of a threaded peg.

The chosen adjoining and surmounting arrangement of the individual structural parts 1 in FIG. 1 yields in the area of the four sequentially facing edges of a side wall of the adjoining parts 1 through the linkage of the adjoining connecting elements 2 in these edges a connector unit 3 which, when joined together in the present exemplified embodiment, forms a round peg, for example with a complete external thread.

Onto this threaded peg 3, built by the linkage, it is then possible for secure connection to screw on as a locking element 4 an internally threaded nut 4. In this fashion, the nut 4 surmounting all quarter segments of the threaded peg 3, ensures a sturdy connection of all four structural parts 1.

FIG. 2 illustrates an alternative embodiment which may be combined with the embodiment as per FIG. 1, wherein each structural part 1 exhibits roughly in the middle of the edge 1a of a housing wall a connecting element 2, whereby such connecting element 2 in this example presents a roughly semi-circular cross-section, thereby forming the longitudinally cut half for example of a threaded peg.

The described assembly of structural parts 1 thus yields along the adjacent edges 4 of two structural parts, through the linkage of connecting elements 2, by comparison to FIG. 1, a fully structured threaded peg 3, onto which, in the manner described, for a secure connection, an internally threaded locking element 4, for example a nut, may be screwed on. This, too, affords a suitably sturdy connection of the individual structural parts.

FIG. 3 shows in perspective a cross-section through a locking element 4 in the shape of an internally threaded nut, featuring in its rear area a hexagonal socket 4a for a hex wrench.

On the locking element 4 facing the end of the structural part, ahead of thread 4b there is a conically shaped guiding surface 4c, matching a similarly built guiding surface at the threaded end of a connector unit facing the structural part. Accordingly, when such a locking element 4 is screwed on, the conical guiding surface 4c of the locking element and the corresponding guiding surface of the connector unit come into contact, generating a resulting component of forces, attracting the parts 1 to each other as the connecting element 4 is screwed on.

FIG. 4 further shows an embodiment in lateral cross-section through a connector unit formed by two connecting elements 2, forming in this instance a threaded peg which in this case features a conical shape. The diameter of the external threading of the composite connector unit tapers off outwardly to a declining diameter, whereby, the locking element 4, designed to be screwed onto the threaded peg, features a corresponding thread pitch 4b. This also makes it clear that a component of forces is exerted onto the connector unit as the locking element is screwed on, drawing the parts 1 onto each other for a secure fit.

In this cross-sectional view it is also manifest that the appropriate connecting elements 2 combined into a connector unit form in this instance about one half of the combined threaded peg, whereby a small gap 5 remains between the connecting elements 2 after one linkage, in order to ensure a sturdy superposition of parts 1. This also works to create an effective tapering off of the material in the connecting elements 2, which may contribute to a slight springiness of the connecting elements. A residual spring force may persist between the drawn-together connecting elements 2 as the locking element 4 is screwed on.

Provision may be made for such a tapering off of the material and/or such a gap, apart from the embodiment illustrated here, with two approximately half-shaped threaded pegs, as well as with the quarter-shaped connecting elements in the corners of a lateral wall of a structural part.

FIG. 5 shows in cross-section as an addition a cover 6, which may be for example mounted on an unused connecting element 2. In particular, provision may be made for a snap-on connection between such an unused connecting element 2 and the cover 6, as reinforcement.

As a concrete example in different projections, FIG. 6 shows structural parts according to the invention, designed here as housing wall elements 1 of an electronic housing. Such a housing wall element 1 may be secured onto a housing wall, not illustrated here, for example by screwing on.

In the case of the three housing wall elements 1 shown here the one above the other, connecting elements 2 according to the invention are in every case mounted on the upper and the lower edge of the lateral wall 2. Here, two of the connecting elements 2 of two adjoining housing wall elements 1 facing each other, form a connecting unit designed in this example as a round threaded peg. There is a locking nut, not illustrated here. Basically, FIG. 6 design matches the illustration shown in FIG. 2.

It will also be noted here that a ribbed coolant body is mounted between the connecting elements 2 on the housing wall element, further contributing to better heat dissipation.

FIG. 7 shows the housing wall elements 1 from FIG. 6 in an arrangement of two electronic housings, intended to be stacked the one over the other and bound together. It will be observed that once the housings are set the one over the other, every two connecting elements 2 will form a connector unit in the shape of a threaded peg onto which a locking element 4 may be screwed on. Covering elements 6 may be placed on the unused connecting elements 2 on the terminal upper edge of the top housing and the lower edge of the bottom housing.

As compared to the state-of-the-art solutions, the system of structural components according to the invention has the special advantage that in an arrangement of a number of adjoining and superimposed structural parts 1, it is readily possible to remove one single part out of this composite. To this end, all it takes is to remove the locking elements from the connecting elements 2 of the laterally contiguous structural parts, so as to loosen the connection of the desired part from the composite. The part can then be removed and, for example, exchanged for another.

This application claims priority from German Application 10 2004 007 742.8 filed on Feb. 26, 2004 which is hereby incorporated by reference herein.

1. A system of structural components for the inter-connection of adjoining, structural parts, each structural part having connecting elements and at least two connecting elements of adjoining structural parts being joinable by arranging structural parts next to and/or above each other into a connector unit whose coupling may be achieved by a locking element which connects all joined connecting elements with each other wherein a connector unit forms an externally threaded peg on which a locking element may be screwed, or that b) between the connector unit and the locking element a bayonet mount and/or a snap-on connector is formed.

2. A system of structural components according to claim 1, wherein in the area of at least one side of a lateral wall of a structural part there is arranged at least one connecting element, and wherein two connecting elements facing each other on structural parts arranged adjoining each other may be joined into a connector unit.

3. A system of structural components according to claim 1, wherein in an area of at least one corner on one lateral wall of a structural part there is arranged a connecting element, and wherein four connecting elements of structural parts arranged next to and above each other may be joined into a connector unit.

4. A system of structural components according to claim 1, wherein the peg has a diameter that tapers off outward and reduces the diameter of the thread, whereby the locking element has a corresponding threaded pitch diminishing in diameter.

5. A system of structural components according to claim 1, wherein at the end of a connector unit at a side of the structural part a conical guiding face is formed, which matches with a guiding face at an end of a locking element facing the structural part.

6. A system of structural components according to claim 1, wherein a gasket is arranged between joined connecting elements.

7. A system of structural components according to claim 1, wherein the counter opposed boundary surfaces of linkable connecting elements comprise matching centering aids.

8. A system of structural components according to claim 1, wherein the connecting elements comprise interfaces for electrical connection between adjoining structural parts.

9. A system of structural components according to claim 1, wherein one of the structural parts is an electronic housing.

10. A system of structural components according to claim 1, wherein one of the structural parts is a wall element to be secured onto a housing.
